(19) United States
(12) Patent Application Publication
(10) Pub. No.: US 2014/0122155 A1
(43) Pub. Date: May 1, 2014

(54) WORKFORCE SCHEDULING SYSTEM AND METHOD

(71) Applicant: WAL-MART STORES, INC., Bentonville, AR (US)

(72) Inventor: Theo Smith, JR., Bentonville, AR (US)

(73) Assignee: Wal-Mart Stores, Inc., Bentonville, AR (US)

(21) Appl. No.: 13/662,586

(22) Filed: Oct. 29, 2012

(51) Int. Cl. G06Q 10/06

(52) U.S. Cl. 705/7.21

(57) ABSTRACT

A method and system for determining workforce scheduling provides historical delivery time data measured from an order date and time of a current product order for prior product deliveries, where the historical delivery time data is weighted, averaged and smoothed to derive an average delivery time which is added to the order date and time of the current order to yield an estimated delivery arrival date and time for the current product order. Employees are then scheduled to work in accordance with the estimated delivery arrival date and time of the current product order.

### FIELD OF THE INVENTION

The present invention relates generally to a workforce scheduling method and system, and more specifically, to a method and system for estimating manpower needs for receiving and stocking personnel in stores that receive shipments of goods.

### BACKGROUND

Store managers prefer to schedule their backroom receiving personnel to accommodate deliveries. Currently some stores capture invoices created at shipment distribution centers for the stores to identify what products will be shipped, then estimates of shipment data are used to create a work schedule for unloading the freight to be delivered in the future. However, the current system does not take into account seasonal trends in shipping variations. Moreover, invoices are not available from all sources of freight shipments, particularly for direct shipment deliveries from sources other than the usual shipment distribution centers for special orders, and for imports from foreign countries.

Known delivery forecasting engines in the retail industry focus on the demand for the product and the orders, lead time and safety stock required to ensure that sufficient stock is on hand to meet customer demand. Typically the commercial carrier will contact the store and schedule a delivery. However, there are many factors that may influence the delivery of products such as the weather, labor strikes, increased demand on holidays.

Prior forecasting methods are typically based on when the transportation team estimates that their shipment will arrive. If this information is not available, then no forecast of the delivery is possible. Most third party transportation companies that operate outside of the US do not provide this type of information. Also, the current delivery process is not able to forecast the delivery of ‘direct ships’ that are shipped from the supplier's warehouse directly to a store.

### BRIEF SUMMARY OF EMBODIMENTS

A method for determining workforce scheduling needs includes first gathering historical product shipment data for past shipments of similar products from a warehouse to a store. The historical product shipment data may include the date and time of creation of product orders, the arrival dates and times of deliveries to the store, and the travel times of the shipments measured as the difference between the dates and times of order creation to the dates and times of deliveries to the store. An average prior delivery travel time is determined from the historical product shipment data, and a future delivery arrival date and time for a current product order is estimated by adding the average prior delivery travel time to the current date and time of the current order. Once the estimated arrival date and time are estimated, then employees are scheduled to handle the delivery at the store.

A computer readable storage medium includes computer readable program code which operates on a computer system. The code processes the steps of: accessing historical product shipment data for shipments of products from a warehouse to a store, the historical product shipment data including prior delivery travel times measured from creation dates and times of prior product orders to delivery of the prior product shipments at the store, and prior delivery arrival dates and times for arrival of the prior product shipments at the store and determining an average prior delivery travel time of the historical product shipment data; estimating a delivery arrival date and time of the current product order by adding the average prior delivery travel time to the current date and time; and scheduling employees to work at the store in accordance with the estimated delivery arrival date and time of the current product order.

A computer system for determining workforce scheduling needs includes an input device, a memory unit and a processing unit. The input device receives a current product order to be scheduled for shipment. The current product order is stored in the memory unit. The processing unit retrieves historical product shipment data from the memory unit in response to the creation of the current product order. The processing unit then determines an average prior delivery travel time of the historical product shipment data, estimates a delivery arrival date and time of the current product order by adding the average prior delivery travel time to the current date and time, and generates a schedule of employees to work at the store in accordance with the estimated delivery arrival date and time of the current product order.

The above and other aspects of various embodiments of the present invention will become apparent in view of the following description, claims and drawings.

### BRIEF DESCRIPTION OF THE SEVERAL VIEWS OF THE DRAWINGS

The accompanying drawings, in which like numerals indicate like structural elements and features in various figures, are not necessarily drawn to scale, the emphasis instead being placed upon illustrating the principles of the invention.

FIG. 1 shows two curves representing weighted delivery time distributions of product shipments;

FIGS. 2A and 2B are a flowchart diagram of a preferred embodiment of the inventive method;

FIG. 3 is a diagram of a system of computers used to implement the invention; and

FIG. 4 is a block diagram of components within a computer to implement the invention.

### DETAILED DESCRIPTION

In the following description, specific details are set forth although it should be appreciated by one of ordinary skill that the systems and methods can be practiced without at least some of the details. In some instances, known features or processes are not described in detail so as not to obscure the present invention.

A preferred embodiment of the process for scheduling manpower needs at a receiving dock of a store includes documenting and utilizing historical shipment data for similar products, or for products ordered and delivered for a particular department within the store. For instance, the historical data can be accumulated for all women's shoes, or for all products associated with the footwear department which can include men's shoes, women's shoes, boots, racks for storing shoes, shoe polish, etc.

The products may be shipped from a product distribution center or from another source. Each store typically has one dedicated product distribution (DC) center which acts as a warehouse for supplying all the standard goods that are available in the store. These standards goods are defined as replenish-able (RP) products. In some cases, a store may be directly linked to more than one product distribution center if necessary to fulfill the demand for replenish-able goods at the store. In other cases it is possible for a single DC center to be responsible for supplying replenish-able goods to more than one store.

A store may periodically offer a special product which is not available from its DC center, but must be ordered and shipped from another source directly to the store. These special order or direct order goods are defined as non-replenish-able (NPP) products. In the case where a former replenish-able RP product is no longer available, a special order for this former RP product can be issued. The other source of goods includes any other warehouse or supplier which is not part of the DC center system of warehouses associated with the store(s). Some special order products may be imported from foreign countries.

Product shipment data for each shipment of each product, or for each store department as the case may be, are stored in a computer system. All stores, DC centers and other suppliers may be linked into the same computer system (such as via Internet access), or the computer system may be located at a single location such as the central office of the store or chain of stores, so long as all product shipment data are eventually supplied to the computer system for archival.

The product shipment data include: (1) product description, (2) the date and time of creation of the product order, and (3) the delivery arrival date and time of the delivery vehicle delivering the products at the store. From the product shipment data the delivery travel time period or time that it takes to deliver this shipment of products to the store can be calculated as the difference between the date and time of the creation of the product order, and the delivery arrival date and time. The delivery vehicle can include, but is not limited to, a truck, a car, a van and depending on the route necessary to make a delivery, multiple vehicles can be used for transporting the products from a DC center or another source to the store. For instance, delivery of a product can include transportation via land, air or sea a truck using cargo ships, airplane and trucks.

One preferred embodiment of the method is directed toward estimating a delivery arrival date and time of a delivery vehicle at a store once a product order is created. Typically batch product orders are created at the central office on a daily basis, so after the (batch) product order is created and input into the computer system, then the method of the invention is utilized to estimate the arrival date and time at the store and, in turn, the store manager can schedule employees accordingly to handle the shipments being received. The method is not limited to batch orders and applies equally to individual product orders.

The preferred date and time of creation of the product order is the exact date and time when the product order, i.e. request for shipment of goods, is created at the home office or central office of the store or stores (such as a chain of stores) and input into the computer system. That information is forwarded to or otherwise accessible to both the DC center or to the other supplier and to the store which will receive the delivery. For instance, if an order of replenish-able RP goods for a shipment of toys is created at the home office, input into the computer and sent to a DC center and its associated store at 4:00 pm EST on Tuesday May 15, 2012 in the United States, then the time of creation of that RP product order is 4:00 pm EST on Tuesday May 15, 2012.

The delivery arrival date and time of the RP product order (in this case, toys) at the destination store and the delivery travel time period are then documented and saved into the computer system for archival purposes. In this example the delivery arrival date and time of the delivery vehicle to the store is 2:00 pm EST on Wednesday May 16, 2012. The actual delivery travel time period, i.e. the time from the creation of the RP product order at the central office to the delivery of the RP product order at the store, in this case is 22 hours.

For the above example, the product shipment data include (1) the product description as toys, (2) the date and time of creation of the product order at 4:00 pm EST on Tuesday May 15, 2012, and (3) the delivery arrival date and time of the delivery vehicle delivering the products at the store at 2:00 pm EST on Wednesday May 16, 2012. The delivery travel time period or time it takes to deliver this product to the store is calculated as the difference between the date and time of creation of the product order and the delivery arrival date and time, i.e. 22 hours.

Product shipment data are accumulated over time and stored on the computer system for all product shipments for every product from every DC center, from every other supply source, and to each store. Over a period of time the archival of shipment data provides a historical record that can be useful in forecasting arrival dates and times of newly created product orders. This is accomplished by determining average product shipment data over a selected period of time. For example, all shipments of toys from a DC center to a store can be averaged for any predetermined time period in accordance with the collected and saved past toys shipment data.

A set of instructions for the method within the computer system creates a forecast that a store manager can utilize to provide an estimate of when a product shipment will arrive at his or her store based on the historical shipment data. He or she thereafter schedules or arranges employees in accordance with the estimated arrival date and time of the product shipment.

Empirical testing has proven that a best estimate for future deliveries is derived by averaging product shipment data, specifically delivery travel time periods and delivery arrival times, during a 7 day period prior to the target date, together with a 7 day period from and including the current date of the preceding year. So an order created on Oct. 16, 2012 would utilize all orders and receipts between Oct. 9 and Oct. 15 in 2012, plus all of the orders and receipts from Oct. 16, 2011 through Oct. 22, 2011. Prior to averaging, the historical product shipment data delivery travel times are weighted from the current date and time of creation of a new product order so that a greater weight is applied to each day of the historical data that is closest to the current date and whereby weighting is reduced for each day further away from the current date.

Continuing with the above example, we have a new product shipment order that is created on the current date of Tuesday Oct. 16, 2012 at 9:00 pm EST for the shipment of lawn mowers from a given DC center to a store. The goal is to estimate an arrival delivery date and time at the store so that the store manager can schedule personnel as needed for handling the delivery at the loading dock, and for handling the stocking of the products as necessary in the store

The method described above is applied in order to forecast the delivery arrival date and time, i.e. the date and time of delivery of the shipment of lawn mowers to the store. In this embodiment the current product shipment data includes (1) the product description (lawn mowers), (2) the current date and time which is the date and time of creation of the product order (9:00 pm EST on Oct. 16, 2012), and (3) the estimated delivery travel time period from the creation of the product order to delivering the shipment to the store. The estimated delivery arrival date and time of the delivery vehicle at the store is calculated by adding the estimated delivery travel time to the current date and time of product order creation.

In this example a seven day window is applied where a first predetermined number N of days equals 7 and a second predetermined number of days M equals 7 of historical product shipment data to forecast an estimated delivery travel time and an estimated delivery arrival date and time at the store. An average prior delivery travel time of the historical product shipment data is calculated from the product shipment data for seven days prior to the current date of Oct. 16, 2012 and for seven days from and including the current date of the prior year. In other words, the historical product shipment data for the dates ranging from Oct. 9, 2012 to Oct. 15, 2012 and from Oct. 16, 2012 to Oct. 22, 2012 include delivery times which are weighted with heavier weighting of data for each date closest to Oct. 16, 2012 and lighter weighting of data for each date closest to the Oct. 16, 2011.

Data for the above example is shown in the following Table I.

TABLE I

| Date of | | | Weighted | | | |
|---|---|---|---|---|---|---|
| Order | Delivery | Statistical | delivery | Mean | | Difference |
| Creation | Time-hrs | Weight | Time-hrs | Average | Difference | Squared |
| 9 Oct. 2012 | 16 | 1.04 | 16.64 | 16.035 | 0.605 | 0.366025 |
| 10 Oct. 2012 | 15 | 1.05 | 15.75 | 16.035 | −0.285 | 0.081225 |
| 11 Oct. 2012 | 8 | 1.06 | 8.48 | 16.035 | −7.555 | 57.078025 |
| 12 Oct. 2012 | 15 | 1.07 | 16.05 | 16.035 | 0.015 | 0.000225 |
| 13 Oct. 2012 | 17 | 1.08 | 18.36 | 16.035 | 2.325 | 5.405625 |
| 14 Oct. 2012 | 16 | 1.09 | 17.44 | 16.035 | 1.405 | 1.974025 |
| 15 Oct. 2012 | 16 | 1.1 | 17.6 | 16.035 | 1.565 | 2.449225 |
| 16 Oct. 2011 | 15 | 1.1 | 16.5 | 16.035 | 0.465 | 0.216225 |
| 17 Oct. 2011 | 10 | 1.09 | 10.9 | 16.035 | −5.135 | 26.368225 |
| 18 Oct. 2011 | 14 | 1.08 | 15.12 | 16.035 | −0.915 | 0.837225 |
| 19 Oct. 2011 | 17 | 1.07 | 18.19 | 16.035 | 2.155 | 4.644025 |
| 20 Oct. 2011 | 16 | 1.06 | 16.96 | 16.035 | 0.925 | 0.855625 |
| 21 Oct. 2011 | 10 | 1.05 | 10.5 | 16.035 | −5.535 | 30.636225 |
| 22 Oct. 2011 | 25 | 1.04 | 26 | 16.035 | 9.965 | 99.301225 |

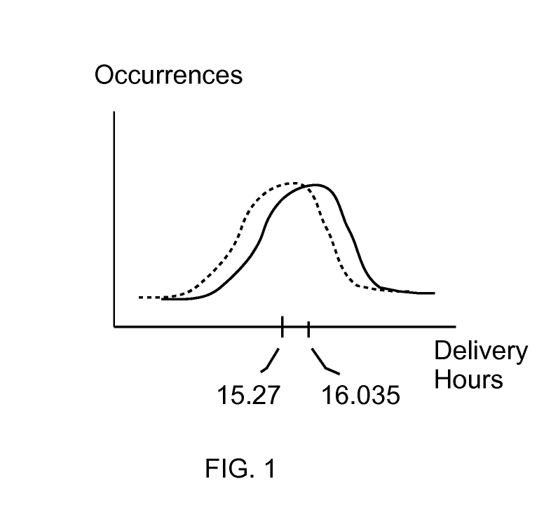

In Table I the delivery times in hours is listed for orders created on the specific dates indicated. For instance, a product order that was created on Oct. 9, 2012 had a delivery time of 16 hours from the creation date and time of the order. The product was delivered from the DC center warehouse to the store 16 hours after the order was created. That Delivery Time was statistically weighted by 1.04 so a Weighted Delivery Time of 16.64 was realized by multiplying 16 times 1.04. The Mean Average weighted delivery time for the 14 entries dated October 9th through October 22nd is 16.035 which was determined by adding each of the Weighted Delivery Times for a sum of 224.49 then dividing the sum by 14. This data distribution is illustrated by the solid curve of FIG. 1 where the delivery time in hours is plotted versus the number of occurrences of various delivery times for the sample. The mean for the solid line curve is shown as 16.035 as calculated from the data in Table I above.

The Difference between the Weighted Delivery Times and the Mean Average delivery time is listed in the Difference column. For instance, for October 9th the Mean Average of 16.035 was subtracted from the Weighted Delivery Time of 16.64 yielding a Difference of 0.605. Then the Difference is squared so for October 9th the Difference Squared is 0.605²=0.366025.

From the data of Table 1, the solid line curve of FIG. 1 is created to illustrate the Weighted Delivery Time data. The sum of the Difference Squared data of Table I is 230.21315 which is divided by the number of table delivery data entries minus 1, i.e. 13. Thus 230.21315 divided by 13 equals 17.7087038. The standard deviation σ=4.2081709 is then calculated as the square root of 17.7087038. Two times the square root 4.2081709 is calculated as 8.4163418 which represents two standard deviations 2σ for this given data. In this preferred embodiment we use two standard deviations, however any predetermined number P of standard deviations can be used, P being a positive integer.

Testing has proven that statistical data provided within a range of two standard deviations from the mean yields good results. Thus the method described will utilize data that falls within two standard deviations above, and two standard deviations below, the mean average of Weighted Delivery Times. In this example, all Weighted Delivery Time data will be used that falls between 16.035-8.4163418=7.618659 and 16.035+8.4163418=24.451341. Since the Weighted Delivery Time of 26 hours for Oct. 22, 2012 is outside of the acceptable data range as calculated above, that data will be dropped, i.e. smoothing the solid line curve of FIG. 1 by removal of the aberrant entry as shown in Table II below.

TABLE II

| | | | Weighted |
|---|---|---|---|
| Date of Order | Delivery | Statistical | Delivery |
| Creation | Time- hrs | Weight | Time - hrs |
| 9 Oct. 2012 | 16 | 1.04 | 16.64 |
| 10 Oct. 2012 | 15 | 1.05 | 15.75 |
| 11 Oct. 2012 | 8 | 1.06 | 8.48 |
| 12 Oct. 2012 | 15 | 1.07 | 16.05 |
| 13 Oct. 2012 | 17 | 1.08 | 18.36 |
| 14 Oct. 2012 | 16 | 1.09 | 17.44 |
| 15 Oct. 2012 | 16 | 1.1 | 17.6 |
| 16 Oct. 2011 | 15 | 1.1 | 16.5 |
| 17 Oct. 2011 | 10 | 1.09 | 10.9 |
| 18 Oct. 2011 | 14 | 1.08 | 15.12 |
| 19 Oct. 2011 | 17 | 1.07 | 18.19 |
| 20 Oct. 2011 | 16 | 1.06 | 16.96 |
| 21 Oct. 2011 | 10 | 1.05 | 10.5 |

The sum of the Weighted Delivery Times of the smoothed data in Table II is 198.49. Recalculating the average Weighted Delivery Time from the entries of Table II is done by dividing 198.49 by 13 entries which equals 15.268461. The mean rounded value of 15.27 is indicated in FIG. 1 for the smoothed data distribution of Table II above which corresponds to the dotted line curve of FIG. 1.

When we round the recalculated average Weighted Delivery Time to 15¼ hours, we can estimate a future delivery date and time for this particular product shipment. In this case, the order creation date and time was 9:00 pm EST on Oct. 16, 2012, so the estimated delivery date and time is 15¼ hours later at 12:15 pm noon on Oct. 17, 2012. The store manager where the delivery will arrive receives this estimated delivery date and time and arranges or schedules his workforce to be prepared for the delivery.

In the above example, we chose a first predetermined value of N=7 for the number of days prior to the current date, and a second predetermined value of M=7 for the number of days from and including the current date of the foremost preceding year. However, the values of N and M can vary and need not be identical. In other embodiments, it is conceivable that forecasted product shipment data can be calculated whereby one of N or M is zero. Further, the method may be altered by selecting a different time period of historical data, for instance, using data over a three month period, using data for some number of days forward from the current date of the preceding year, or using historical data from multiple preceding years.

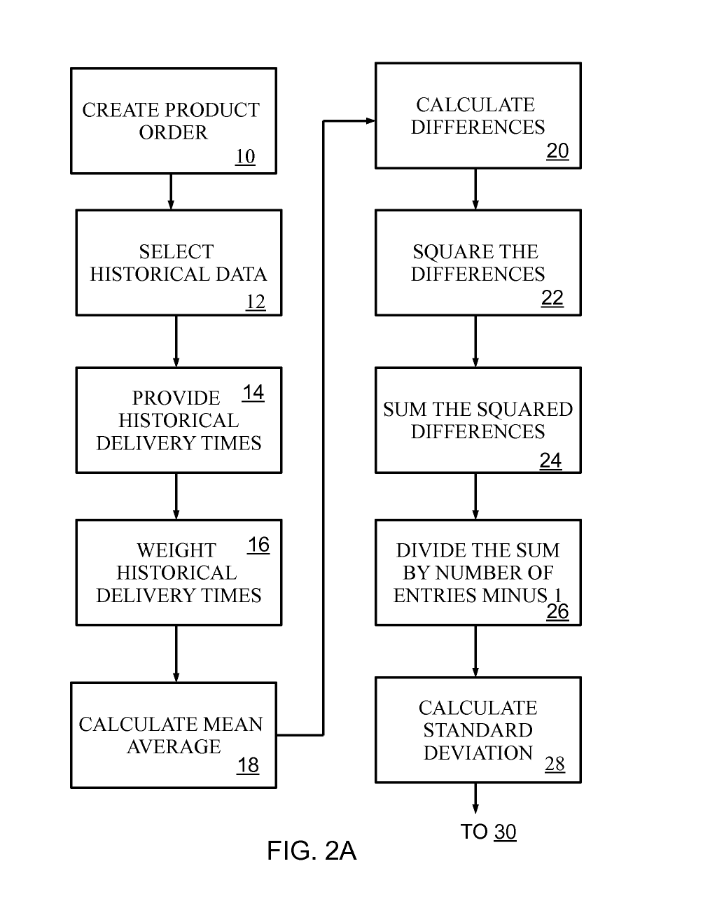

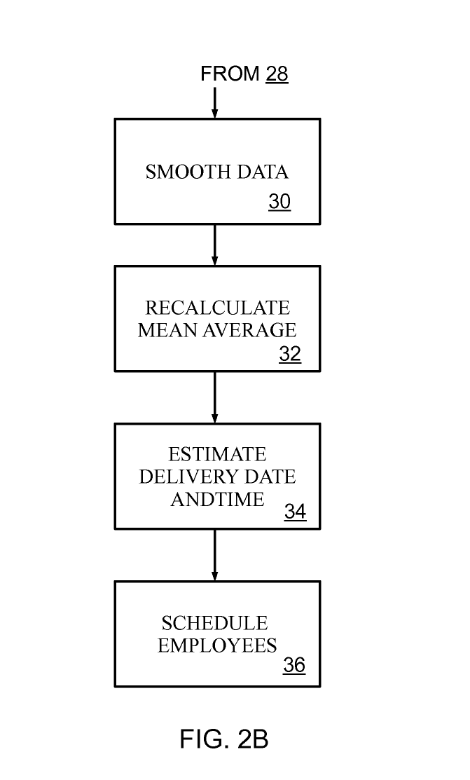

FIGS. 2A and 2B constitute a flowchart representation of a preferred embodiment of the inventive method. In step 10 an order is created on the computer system at the central office for a product shipment from a warehouse to a store. The order creation date and time, which is defined as the current date and time, is saved. In step 12 historical product shipping data is selected from the archives of the computer system. Specific blocks of historical product shipment data can be selected according to various embodiments of the inventive method. Alternately, the historical product shipment data can be programmed in to the computer for given dates as described elsewhere in this document.

The selected historical product shipment data in step 12 is accessed from the storage archives in the computer system which relates to the subject product or product group (e.g. store department classification), the particular warehouse or other source, and the particular store for delivery. The products may be defined by a department classification including, but not limited to, sporting good products, toy products, clothing products, hardware products, lawn and garden products, automotive products, food products and tool products. This partial list is exemplary and various other product groups or product classifications may be included as well.

The historical product shipment data can include: (1) the product description (lawn mowers), (2) the current date and time which is the date and time of creation of the product order (9:00 pm on Oct. 16, 2012), and (3) the estimated delivery travel time period from the creation of the product order to delivering the shipment to the store. Product shipment data may vary from those items selected above and may include, for example, store identification information (e.g. store number, address, size, type), DC or other source warehouse identification information, the method of shipment (e.g. courier, auto, truck, airplane, ship, etc.), weight of products and shipment, request for normal or expedited (fastest) shipping, and any other factors related to the acquisition and shipping of the goods.

Historical delivery times are provided in step 14 from the archives. In step 16 the historical delivery times are weighted and a mean average of the weighted historical delivery times is calculated in step 18. The differences between the weighted delivery times and the mean average are determined in step 20, and each of the differences is squared in step 22. A sum of all the differences squared is calculated in step 24 and the sum is divided by the number of entries or dates of historical data that have been considered minus one in step 26.

The standard deviation is determined in step 28 as the square root of the value calculated in step 26. The method continues in step 30 by smoothing data. In a preferred embodiment we use data spanning across two standard deviations of the average mean delivery time value. Thus the smoothing of step 30 removes any data which falls outside of two standard deviations from the mean average. Of course, this is an arbitrary setting that has been selected based on empirical testing and the data selection may vary if desired, for instance using just one standard deviation or perhaps multiple standard deviations from the norm.

After smoothing has occurred then the average mean delivery time value is recalculated in step 32 for the remaining weighted delivery time data to provide an average estimated delivery time in hours. This value is then added to the current date and time of product order creation to estimate in step 34 a date and time for delivery of the current order at the store. Once the estimated delivery data and time is established, then employees are scheduled to handle the delivery in step 36.

The computer system at the company headquarters, or located at DC centers, other warehouse sources, stores, etc. can be used individually or in a network configuration to provide the means for implementing the inventive method described above. The code for the inventive method may be resident within any computerized system such as, but not limited to, a desktop computer, a laptop computer, a server, a smart phone, a portable computer, etc.

A computer readable storage medium having computer readable program code for the inventive method described above can reside on any computer readable medium such as, but not limited to, a hard drive, a compact disk (CD), a digital video disk (DVD), a flash drive, a portable drive, a memory module, random access memory (RAM), dynamic random access memory (DRAM), read-only memory (ROM), a desktop drive, a universal serial bus (USB) memory stick, a desktop computer, a portable computer, or the like.

A memory device for storing the historically archived product shipment data includes any storage device such as, but not limited to, a hard drive, a CD, a DVD, a flash drive, a portable drive, a memory module, RAM, DRAM, ROM, a desktop drive, a USB memory stick, a desktop computer, a portable computer, or the like.

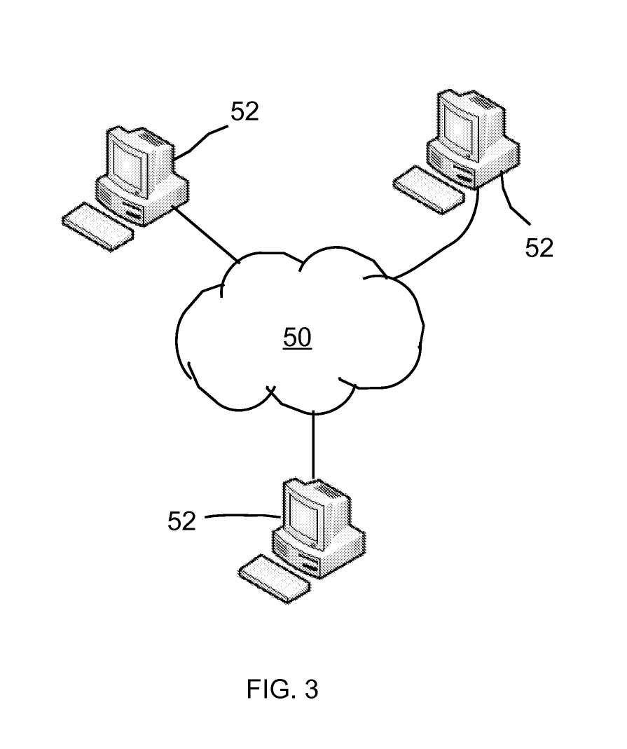

Multiple computers 52 are connected to a network 50 in FIG. 3. The network 50 may be the Internet, a local area network LAN, an ethernet, or the like. The number of computers 52 can vary and each computer can be any type of networking computing device such as a personal computer, a business computer, a server, a laptop, an iPad, etc. As is well known, the computers can communicate with one another over the network.

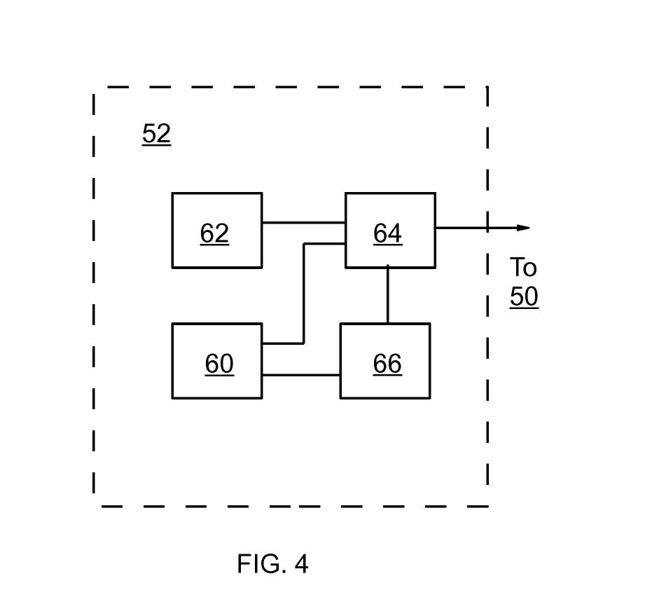

FIG. 4 is a basic block diagram of a computer 52 connected to the network 50 and having an input device 60, a display 62, a processing unit 64 and a memory unit 66. The input device can be any type of input device such as a keyboard, keypad or mouse. In another case, the display 62 can be a touch screen to act as an input device.

An user can view the display 62 and input to create a current product order via the input device 60. The current product order is then stored in the memory unit 66 and sent to the processing unit 64. In response to the current product order the processing unit 64 retrieves historical product shipment data from the memory unit 66. As described in detail in the method above, the processing unit (1) determines an average prior delivery time of the historical product shipment data, (2) estimates a delivery arrival date and time of the current product order by adding the average prior delivery travel time to the current date and time; and (3) generates a schedule of employees to work at the store in accordance with the estimated delivery arrival date and time of the current product order. The generated employee schedule can be output for viewing such as via a display, printer or any other output device.

In one preferred embodiment the current product order is created and input at a computer in the central office, and a work schedule is generated and sent to a computer at the store slated for delivery. In another embodiment, the central office computer can send the current product data and historical data to the computer at the specific store, and the store computer can process the data and generate the employee schedule. The computers connected via the network as shown in FIG. 3 can be located at any location, such as at stores, warehouses, etc. so long as a central database is maintained of historical product shipment data.

The foregoing description of the preferred embodiments of the invention has been presented for purposes of illustration and description only. It is not intended to be exhaustive nor to limit the invention to the precise form disclosed; and obviously many modifications and variations are possible in light of the above teaching. Such modifications and variations that may be apparent to a person skilled in the art are intended to be included within the scope of this invention as defined by the accompanying claims.

What is claimed is:

1. A computer-implemented method for determining workforce scheduling needs, the method comprising:
providing historical product shipment data for shipments of products from a warehouse to a store, the historical product shipment data including prior delivery travel times measured from creation dates and times of prior product orders to delivery of the prior product shipments at the store, and prior delivery arrival dates and times for arrival of the prior product shipments at the store and determining an average prior delivery travel time of the historical product shipment data;
estimating a delivery arrival date and time of the current product order by adding the average prior delivery travel time to the current date and time; and
scheduling employees to work at the store in accordance with the estimated delivery arrival date and time of the current product order.

2. The method of claim 1, wherein the average prior delivery travel time is determined by averaging historical prior delivery travel times for a first predetermined number of days prior to the current date along with historical prior delivery travel times for a second predetermined number of days from and including the current date of the preceding year, wherein the first predetermined number and the second predetermined number are positive integers.

3. The method of claim 2, wherein the prior delivery travel times further include weighting increased for each day of the current year moving closer to the current date, and with weighting increased for each day of the prior year moving closer to the current date of the preceding year.

4. The method of claim 3, further comprising determining a standard deviation of the weighted prior delivery travel times, smoothing the weighted prior delivery travel times to eliminate aberrations within P standard deviations of a mean average, then recalculating the average prior delivery travel time, P being a positive integer.

5. The method of claim 4, wherein the delivery arrival date and time of the current order are determined by adding the recalculated average weighted prior delivery travel time to the current date and time of the current order.

6. The method of claim 1, wherein the warehouse is a product distribution center for providing replenish-able products kept in stock at the store.

7. The method of claim 1, wherein the warehouse is a source for providing non-replenish-able products being special orders for the store.

8. The method of claim 2, wherein the first predetermined number equals 7 and the second predetermined number equals 7.

9. The method of claim 2, wherein the first predetermined number equals 0.

10. The method of claim 1, wherein the products are defined by a department classification.

11. A computer program product, comprising:
a computer readable storage medium having computer readable program code embodied therewith, the computer readable program code comprising:
computer readable program code configured to access historical product shipment data for shipments of products from a warehouse to a store, the historical product shipment data including prior delivery travel times measured from creation dates and times of prior product orders to delivery of the prior product shipments at the store, and prior delivery arrival dates and times for arrival of the prior product shipments at the store and configured to determine an average prior delivery travel time of the historical product shipment data;
computer readable program code configured to estimate a delivery arrival date and time of the current product order by adding the average prior delivery travel time to the current date and time; and
computer readable program code configured to schedule employees to work at the store in accordance with the estimated delivery arrival date and time of the current product order.

12. The computer program product of claim 11 wherein the computer readable program code is configured to determine the average prior delivery travel time by averaging historical prior delivery travel times for a first predetermined number of days prior to the current date along with historical prior delivery travel times for a second predetermined number of days from and including the current date of the preceding year, wherein the first predetermined number and the second predetermined number are both positive integers.

13. The computer program product of claim 12 wherein the computer readable program code is configured to weight the prior delivery travel times by increasing weighting for each day of the current year moving closer to the current date, and by increasing weighting for each day of the prior year moving closer to the current date of the preceding year.

14. The computer program product of claim 13 wherein the computer readable program code is configured to determine a standard deviation of the weighted prior delivery travel times, smoothing the weighted prior delivery travel times to eliminate aberrations within a given number of standard deviations of a mean average, then recalculating the average prior delivery travel time.

15. The computer program product of claim 14 wherein the computer readable program code is configured to determine the delivery arrival date and time of the current order by adding the recalculated average weighted prior delivery travel time to the current date and time of the current order.

16. The computer program product of claim 11 wherein the computer readable program code is configured to access historical product shipment data stored on the computer readable storage medium.

17. The computer program product of claim 11 wherein the computer readable program code is configured to access historical product shipment data stored in a memory device.

18. The computer program product of claim 17 wherein the memory device comprises one of a hard drive, a CD, a DVD, a flash drive, a portable drive, a memory module, RAM, DRAM, ROM, a desktop drive, a USB stick, a memory stick, a desktop computer and a portable computer.

19. The computer program product of claim 11 comprising one of a hard drive, a CD, a DVD, a flash drive, a portable drive, a desktop drive, a USB stick, a memory stick, a desktop computer and a portable computer.

20. A computer system for determining workforce scheduling needs, the system comprising:
an input device to receive a current product order;
a memory unit to store the current product order;
a processing unit to retrieve historical product shipment data from the memory unit for shipments of products from a warehouse to a store in response to the current product order, the historical product shipment data including prior delivery travel times measured from creation dates and times of prior product orders to delivery of the prior product shipments at the store, and prior delivery arrival dates and times for arrival of the prior product shipments at the store,
determining an average prior delivery travel time of the historical product shipment data;
estimating a delivery arrival date and time of the current product order by adding the average prior delivery travel time to the current date and time; and
generating a schedule of employees to work at the store in accordance with the estimated delivery arrival date and time of the current product order.

21. The computer system of claim 20, wherein the processing unit determines the average prior delivery travel time by averaging historical prior delivery travel times for a first predetermined number of days prior to the current date along with historical prior delivery travel times for a second predetermined number of days from and including the current date of the preceding year, wherein the first predetermined number and the second predetermined number are positive integers.

22. The computer system of claim 21, wherein the processing unit processes the prior delivery travel times by weighting, being increased for each day of the current year moving closer to the current date, and being increased for each day of the prior year moving closer to the current date of the preceding year.

23. The computer system of claim 22, wherein the processing unit determines a standard deviation of the weighted prior delivery travel times, smoothing the weighted prior delivery travel times to eliminate aberrations within P standard deviations of a mean average, then recalculates the average prior delivery travel time, P being a positive integer.

24. The computer system of claim 23, wherein the processing unit determines the delivery arrival date and time of the current order by adding the recalculated average weighted prior delivery travel time to the current date and time of the current order.

25. The computer system of claim 20, wherein the warehouse is a product distribution center for providing replenish-able products kept in stock at the store.

26. The computer system of claim 20, wherein the warehouse is a source for providing non-replenish-able products being special orders for the store.

27. The computer system of claim 21, wherein the first predetermined number equals 7 and the second predetermined number equals 7.

28. The computer system of claim 22, wherein the first predetermined number equals 0.

29. The computer system of claim 21, wherein the products are defined by a department classification.

30. The computer system of claim 20, further comprising an output device to output the schedule.
